(19) United States
(12) Patent Application Publication
(10) Pub. No.: US 2015/0175192 A1
(43) Pub. Date: Jun. 25, 2015

(54) RACK TYPE ELECTRIC POWER STEERING SYSTEM

(71) Applicant: Mando Corporation, Pyeongtaek-si (KR)

(72) Inventor: Jun Ho Sin, Wonju-si (KR)

(73) Assignee: Mando Corporation, Pyeongtaek-si (KR)

(21) Appl. No.: 14/308,351

(22) Filed: Jun. 18, 2014

(30) Foreign Application Priority Data
Dec. 24, 2013 (KR) 10-2013-0162399

(51) Int. Cl. B62D 5/04

(52) U.S. Cl. CPC B62D 5/0484; B62D 5/046

(57) ABSTRACT

The present invention relates to a rack type electric power steering system. The present invention provides a rack type electric power steering system including: a power steering motor comprising a motor housing accommodating a rotor to which a motor shaft is coupled and a stator accommodating the rotor therein, and a front cover having a shaft through-hole for protruding a distal end of the motor shaft to the outside at a portion thereof and coupled to the motor housing such that an inner surface thereof faces the interior of the motor housing; a moisture detection sensor attached to a lower end of an inner surface of the front cover, which is adjacent to the shaft through-hole; and a controller for, if receiving a moisture detection signal of a predetermined value or higher from the moisture detection sensor, stopping driving of the power steering motor.

### CROSS-REFERENCE TO RELATED APPLICATION

This application claims priority from and the benefit under 35 U.S.C. §119(a) of Korean Patent Application No. 10-2013-0162399, filed on Dec. 24, 2013, which is hereby incorporated by reference for all purposes as if fully set forth herein.

### BACKGROUND OF THE INVENTION

1. Field of the Invention

The present invention relates to a rack type electric power steering system.

2. Description of the Prior Art

As vehicle technologies have been rapidly developed, the technology of various units for driver convenience has also been continuously developed.

Among them, a rack type electric power steering system transmits, to the rack 110, auxiliary steering power, for manipulation of a steering wheel, of an electric motor 120 mounted around a rack 110 to allow the driver to easily manipulate the steering wheel.

In the rack type electric power steering system according to the related art, the electric motor 120 is located at a lower portion of the vehicle and vibrations generated while the vehicle is driven are transmitted to a belt pulley housing 140 through a tie rod 150, an aperture may be generated at a coupling portion of a belt pulley housing 140 or a coupling portion of the electric motor 120 and the belt pulley housing 140 if the vehicle is aged, in which state when the vehicle is driven on a wet road for a long time or a lower part of the vehicle is submerged in water, moisture permeates into the aperture and then into the interior of the electric motor 120. In contrast, because driving vibrations are directly transmitted to a coupling portion of the electric motor 120 and the ECU cover 160, there is little possibility of generating an aperture.

If an excessive amount of moisture penetrates the electric motor 120, a short circuit may be generated in a substrate and a bus bar in the motor, and, accordingly, the electric motor 120 may break down and driving of the electric motor 120 may be stopped, hampering driving safety and requiring costs to repair the electric motor 120.

### SUMMARY OF THE INVENTION

In the background, an aspect of the present invention is to provide a rack type electric power steering system in which a moisture detection sensor is attached to a power steering motor to detect moisture penetrating into a power steering motor, and when moisture is detected, an alarm signal signifying the detection of moisture is generated and driving of the power steering motor is stopped.

In accordance with an aspect of the present invention, there is provided a rack type electric power steering system including: a power steering motor comprising a motor housing accommodating a rotor to which a motor shaft is coupled and a stator accommodating the rotor therein, and a front cover having a shaft through-hole for protruding a distal end of the motor shaft to the outside at a portion thereof and coupled to the motor housing such that an inner surface thereof faces the interior of the motor housing; a moisture detection sensor attached to a lower end of an inner surface of the front cover, which is adjacent to the shaft through-hole; and a controller for, if receiving a moisture detection signal of a predetermined value or higher from the moisture detection sensor, stopping driving of the power steering motor.

In accordance with another aspect of the present invention, there is provided a rack type electric power steering system comprising: a power steering motor comprising a motor housing accommodating a stator and a rotor and an Hall IC substrate attached to a rear end of the motor housing; a moisture detection sensor attached to a portion of the Hall IC substrate; and a controller for, if receiving a moisture detection signal of a predetermined value or higher from the moisture detection sensor, stopping driving of the power steering motor.

As described above, according to the present invention, because a moisture detection sensor is attached to a location of a front cover of a power steering motor, which is adjacent to a sealing bearing coupling portion through which the penetration of moisture is most likely, moisture penetrating into the interior of the power steering motor can be promptly detected.

In addition, because the moisture detection sensor is attached to a portion of the Hall IC substrate installed at the rear end of a motor housing, it is easy to attach a moisture detection sensor and a length of a signal line for a moisture detection sensor for electrically connecting a moisture detection sensor and a controller can be shortened.

### BRIEF DESCRIPTION OF THE DRAWINGS

The above and other objects, features and advantages of the present invention will be more apparent from the following detailed description taken in conjunction with the accompanying drawings, in which:

FIG. 1 is a view schematically showing a configuration of a rack type electric power steering system according to the related art;

FIG. 2 is a view schematically showing a configuration of a rack type electric power steering system according to a first embodiment of the present invention;

FIG. 3 is a view for explaining an attached position of a moisture detection sensor according to a first embodiment of the present invention; and

FIG. 4 is a view schematically showing a configuration of a rack type electric power steering system according to a second embodiment of the present invention.

### DETAILED DESCRIPTION OF THE EXEMPLARY EMBODIMENTS

Hereinafter, exemplary embodiments of the present invention will be described with reference to the accompanying drawings. In the description of the elements of the present invention, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

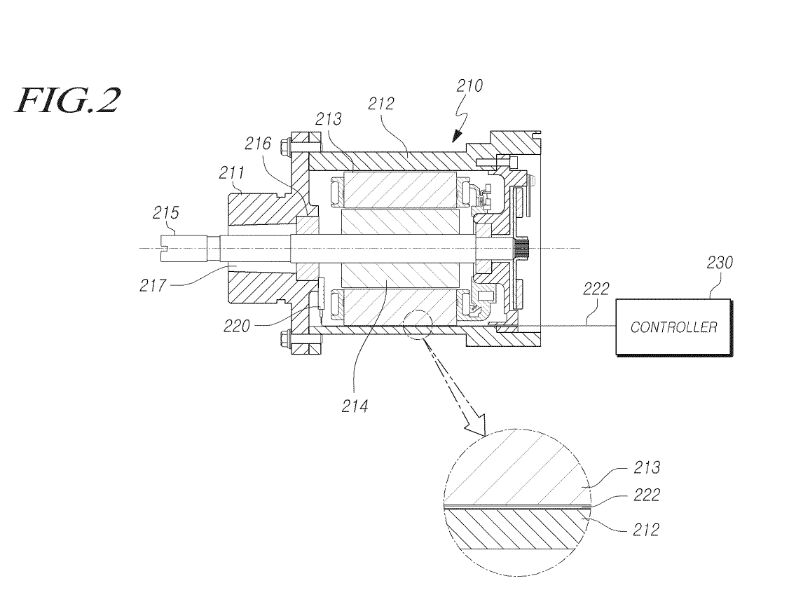

FIG. 2 is a view schematically showing a configuration of a rack type electric power steering system according to an embodiment of the present invention.

A rack type electric power steering system according to a first embodiment of the present invention includes a power steering motor 210, a moisture detection sensor 220, and a controller 230.

The power steering motor 210 includes a motor housing 212 accommodating a rotor 214 to which a motor shaft 215 is coupled and a stator 213 accommodating the rotor 214 therein, and a front cover 211 having a shaft through-hole 217 for protruding a distal end of the motor shaft 215 to the outside at a portion thereof and coupled to the motor housing 212 such that an inner surface thereof faces the interior of the motor housing 212.

The moisture detection sensor 220 is a sensor for detecting moisture to output an electrical signal, and includes an infrared ray absorption type, a microwave type, and an electrical resistance type.

The moisture detection sensor 220 detects moisture penetrating the interior of the motor housing 212 and generates a moisture detection signal to transmit the moisture detection signal to the controller 230, which will be described below.

The moisture detection sensor 220 is attached to a lower end of the inner surface of the front cover 211 adjacent to the shaft through-hole 217.

Specifically, moisture is most likely to penetrate into the power steering motor 210 through a sealing bearing 216 coupled to the shaft through-hole 217, and if moisture excessively permeates through an aperture generated at a coupling portion of a belt pulley housing 140 or a coupling portion between the power steering motor 210 and the belt pulley housing 140 as in the related art, liquid state moisture may penetrate into the motor housing 212 through a gap between the sealing bearing 216 and the shaft through-hole 217. In this case, the liquid state moisture flows to the lower end of the inner surface of the front cover 211, and starts to gather on the bottom surface of the motor housing 212.

Here, if the moisture detection sensor 220 is attached to the lowermost surface of the motor housing 212, it is more likely to detect the liquid state moisture which gathers on the bottom surface of the motor housing 212, and thus the moisture detection sensor 220 cannot promptly detect that the liquid state moisture penetrates into the motor housing 212.

In contrast, if the moisture detection sensor 220 is attached to the lower end of the inner surface of the front cover 212, which is a path along which liquid state moisture flows, the moisture detection sensor 220 may promptly detect that the liquid state moisture starts to penetrate into the motor housing 212.

Accordingly, in the first embodiment of the present invention, the moisture detection sensor 220 is attached to the lower end of the inner surface of the front cover 211, which is adjacent to the shaft through-hole 217, to promptly detect moisture penetrating into the motor housing 212.

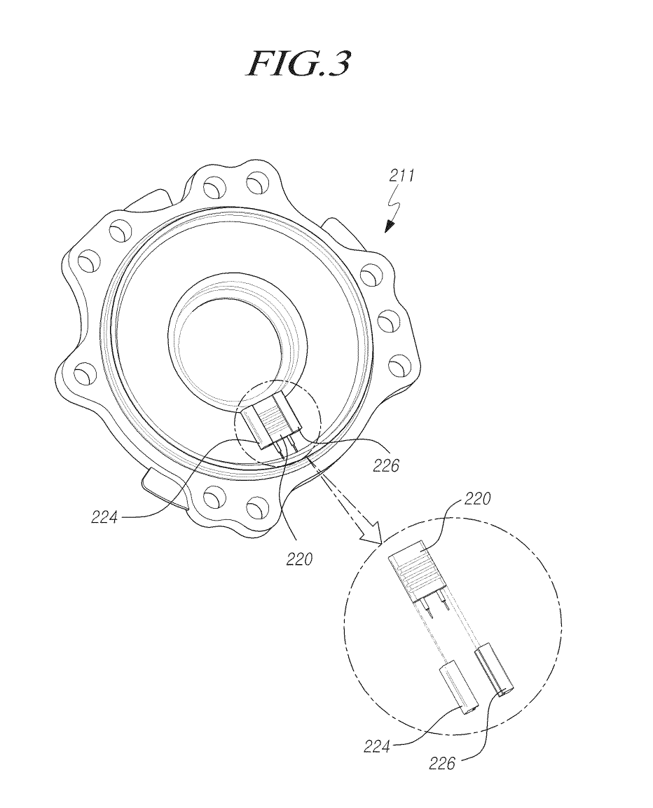

Here, in order to attach the moisture detection sensor 220 to the lower end of the inner surface of the front cover 211, a first rib 224 and a second rib 226 coupled to opposite ends of the moisture detection sensor 220 to fix the moisture detection sensor 220 as shown in FIG. 3 may be formed at the lower end of the inner surface of the front cover 211. Here, as indicated in a dotted circle of FIG. 3, the first rib 224 and the second rib 226 may have coupling recesses by which opposite ends of the moisture detection sensor 220 are slidably coupled to the first rib 224 and the second rib 226 on surfaces.

The moisture detection sensor 220 may be attached to the lower end of the inner surface of the front cover 211 by using a screw or an adhesive.

Meanwhile, if the moisture detection sensor 220 is attached to the lower end of the inner surface of the front cover 211, a signal line 222 for a moisture detection sensor, which electrically connects the moisture detection sensor 220 and the controller 230, extends towards the rear end of the motor housing 212 through a bottom surface of the motor housing 212 to be connected to the controller 230. Here, as indicated in a dotted circuit of FIG. 2, the signal line 222 for a moisture detection sensor extends towards the rear end of the motor housing 212 through a space between the bottom surface of the motor housing 212 and the stator 213.

That is, because the signal line 222 for a moisture detection sensor extends towards the rear end of the motor housing 212 through the bottom surface of the motor housing 212 while one end thereof is electrically connected to the moisture detection sensor 220 and an opposite end thereof is extracted from the rear end of the motor housing 212 to be electrically connected to the controller 230, the signal line 222 for a moisture detection sensor can be protected from an impact generated outside the motor housing 212. Here, a signal line fixing recess through which the signal line 222 for a moisture detection sensor is introduced into an inside of the bottom surface of the motor housing 212 to be fixed may be formed on the bottom surface of the motor housing 212 in a lengthwise direction of the motor housing 212.

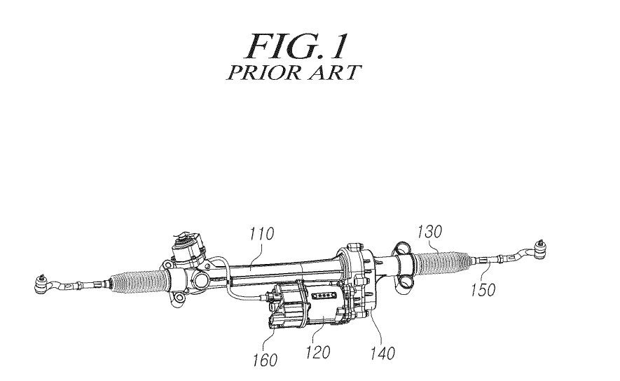

The controller 230 is an Electronic Control Unit (ECU) for controlling an overall operation of the rack type electric power steering system. As shown in FIG. 1, the controller is accommodated in an ECU cover 160 coupled to a rear end of the power steering motor 210 to be protected from an external impact.

According to the present invention, if receiving a moisture detection signal of a predetermined value or higher from the moisture detections sensor 220, that is, if receiving a moisture detection signal that indicates a large amount of moisture, which may be likely to generate a short circuit in the power steering motor 210 from the moisture detection sensor 220, the controller 230 performs a control to stop driving the power steering motor 210 to prevent a breakdown of the power steering motor 210 due to the short circuit.

Meanwhile, if receiving a moisture detection signal of a predetermined value or lower from the moisture detection sensor 220, that is, if receiving a moisture detection signal that indicates a small amount of moisture which rarely generates a short circuit in the power steering motor 210 from the moisture detection sensor 220, an alarm signal signifying detection of moisture is generated and a control for maintaining driving of the power steering motor 210 may be performed.

In this case, the driver may visually or audibly identify an alarm signal signifying detection of moisture, and may drive the vehicle to a garage to repair the vehicle while a normal auxiliary steering force is received from the rack type electric power steering system.

In this way, in the first embodiment of the present invention, the moisture detection sensor 220 is attached to the lower end of an inside of the front cover 211 of the power steering motor 210 to promptly detect moisture when liquid state moisture penetrates the motor housing 212.

In the second embodiment of the present invention, the attachment location of a moisture detection sensor 220 which can detect moisture when moisture having penetrated into the motor housing 212 exists in the motor housing 212 in the state of vapor will be described.

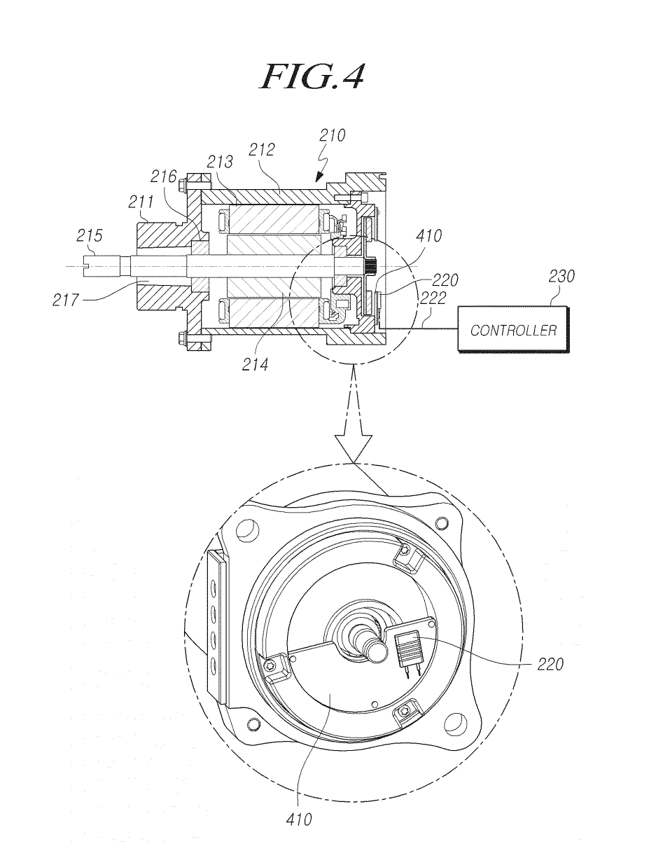

FIG. 4 is a view schematically showing a configuration of a rack type electric power steering system according to a second embodiment of the present invention.

Although liquid state moisture may penetrate into the motor housing 212 as in the first embodiment of the present invention, vapor state moisture may penetrate into the motor housing 212, or liquid state moisture may penetrate into the motor housing 212 and then is vaporized due to the heat in the steering motor 210 to exist in the motor housing 212 in a vapor state.

If an excessive amount of vapor state moisture exists in the motor housing 212, a short circuit of the power steering motor 210 may be generated by the vapor state moisture.

In the second embodiment of the present invention, when a motor position sensor of the rack type electric power steering system is of a Hall IC type, the moisture detection sensor 220 is attached to a portion of a Hall IC substrate as shown in FIG. 4.

Specifically, if vapor state moisture exists in the motor housing 212, the vapor state moisture existing in the motor housing 212 is discharged through gaps existing at a rear end of the motor housing 212 as shown in FIG. 4 to be filled in the ECU cover 160 shown in FIG. 1. Accordingly, the moisture detection sensor 220 is not attached to the lower end of the inner surface of the front cover 211, but is attached in a marginal space of the preexisting Hall IC substrate 410 to detect vapor state moisture at the rear end of the motor housing 212.

If the moisture detection sensor 220 is attached in the marginal space of the Hall IC substrate 410 preexisting in the power steering motor 210 as in the second embodiment of the present invention, the moisture detection sensor 220 may be easily attached to the substrate through simple soldering without attaching the moisture detection sensor 220 using screws or an adhesive, or changing a design of a portion of the power steering motor 210 to couple the moisture detection sensor 220. In addition, because a distance between the controller 230 located in the ECU cover 160 and the moisture detection sensor 220 is short as shown in FIG. 4, a length of the signal line 222 for a moisture detection sensor for electrically connecting the moisture detection sensor 220 and the controller 230 may be shortened.

Even if it was described above that all of the components of an embodiment of the present invention are coupled as a single unit or coupled to be operated as a single unit, the present invention is not necessarily limited to such an embodiment. At least two elements of all structural elements may be selectively joined and operate without departing from the scope of the present invention. Although the embodiments of the present invention have been described for illustrative purposes, those skilled in the art will appreciate that various modifications, additions and substitutions are possible, without departing from the scope and spirit of the invention. The scope of the present invention shall be construed on the basis of the accompanying claims in such a manner that all of the technical ideas included within the scope equivalent to the claims belong to the present invention.

What is claimed is:

1. A rack type electric power steering system comprising:
a power steering motor comprising a motor housing accommodating a rotor to which a motor shaft is coupled and a stator accommodating the rotor therein, and a front cover having a shaft through-hole for protruding a distal end of the motor shaft to the outside at a portion thereof and coupled to the motor housing such that an inner surface thereof faces the interior of the motor housing;
a moisture detection sensor attached to a lower end of an inner surface of the front cover, which is adjacent to the shaft through-hole; and
a controller for, if receiving a moisture detection signal of a predetermined value or higher from the moisture detection sensor, stopping driving of the power steering motor.

2. The rack type electric power steering system of claim 1, further comprising a signal line for a moisture detection sensor connecting the moisture detection sensor and the controller, extending towards the rear end of the motor housing through a bottom surface of the interior of the motor housing while one end thereof is electrically connected to the moisture detection sensor, and of which an opposite end is extracted from the rear end of the motor housing to be electrically connected to the controller.

3. The rack type electric power steering system of claim 1, wherein a first rib and a second rib coupled to opposite ends of the moisture detection sensor to fix the moisture detection sensor are formed at the lower end of an inner surface of the front cover.

4. The rack type electric power steering system of claim 3, wherein coupling recesses for slidably coupling opposite ends of the moisture detection sensor to the first rib and the second rib are formed surface of the first rib and the second rib.

5. The rack type electric power steering system of claim 1, wherein if receiving a moisture detection signal of a predetermined value or lower from the moisture detection signal, the controller generates an alarm signal signifying the detection of moisture and maintains driving of the power steering motor.

6. A rack type electric power steering system comprising:
a power steering motor comprising a motor housing accommodating a stator and a rotor and an Hall IC substrate attached to the rear end of the motor housing;
a moisture detection sensor attached to a portion of the Hall IC substrate; and
a controller for, if receiving a moisture detection signal of a predetermined value or higher from the moisture detection sensor, stopping driving of the power steering motor.

7. The rack type electric power steering system of claim 6, wherein if receiving a moisture detection signal of a predetermined value or lower from the moisture detection signal, the controller generates an alarm signal signifying the detection of moisture and maintains driving of the power steering motor.
